(19) United States
(12) Patent Application Publication
(10) Pub. No.: US 2016/0299954 A1
(43) Pub. Date: Oct. 13, 2016

(54) PROCESSING A SEARCH QUERY AND RANKING RESULTS FROM A DATABASE SYSTEM OF A NETWORK COMMUNICATION SOFTWARE

(71) Applicants: Vinay Bawri, Kolkata (IN); Ritesh Bawri, Kolkata (IN); Malvika Bawri, Kolkata (IN)

(72) Inventors: Vinay Bawri, Kolkata (IN); Ritesh Bawri, Kolkata (IN); Malvika Bawri, Kolkata (IN)

(21) Appl. No.: 15/093,524

(22) Filed: Apr. 7, 2016

(30) Foreign Application Priority Data
Apr. 8, 2015 (IN) 1023/KOL/2014

(51) Int. Cl. G06F 17/30; H04L 12/58

(52) U.S. Cl. CPC G06F 17/30528; G06F 17/3053; G06F 17/30525; H04L 51/046

(57) ABSTRACT

The present disclosure discloses a hardware processor implemented methods and systems for searching and ranking chat sessions or conversations in a user computing device having a chat contact database or data structure. A chat contact database or data structure can include a plurality of chat records exchanged with different people. The systems and method can process a search query to retrieve records from a database. Further, search context(s) may be identified. Furthermore, the retrieved search results may be ranked based on predefined hierarchy criteria. The ranked results may be sorted based on ranking associated with retrieved search result. Finally sorted results can be displayed.

### CROSS REFERENCE TO RELATED APPLICATIONS

This complete specification is filed in pursuance of the provisional Indian patent application numbered 1023/KOL/2014 filed at Indian Patent Office on 8 Apr. 2015.

### FIELD OF THE DISCLOSURE

The present disclosure relates to the field of data processing, and more particularly relates to method and system for processing a search query, retrieving results from a database system or a data structure, and ranking chat sessions running in a user computing device.

### BACKGROUND OF THE DISCLOSURE

In today's world internet users frequently communicate over the internet through chat applications and/or instant messaging services, such as

WhatsApp™, Gchat™, Skype, Yahoo Messenger, and the like. At times, it becomes difficult to search and retrieve data, such as image, file from a chat session on a chat application.

Usually, a user has to use conventional inbuilt programs and/or search platforms for processing searching and retrieving of a specific chat session over said chat application/instant messaging service. However, the searching capabilities of such inbuilt programs are very limited and the search ‘blindly’ matches the search term as entered by the user and presents a number of chat sessions. Further, in such inbuilt programs, the final search results are shown in chronological order without ranking the results of specific chat sessions and individual messages based on their relevance to the search term and to the user.

In such a case, the user has to scroll and scan through multiple search results displayed to identify the relevant chat messages according to his requirements. So, the whole process is time consuming and frustrating and requires a lot of user's intervention.

However, there are some other searching modules adapted for searching the specific chat sessions and/or chat conversations based on a contact name, email address as stored on a contact database of such chat application. But, the ability of all of the existing searching and ranking modules is limited, and requires considerable improvement.

Few solutions have been developed in recent years to facilitate communication history aggregation and presentation of conversations to the user. For example, the U.S. Patent Publication No. 2013/0204888 discloses a unified communication application that allows a user to communicate with contacts across multiple electronic communication services.

The said unified communication application aggregates communication history between the user and another person. A set of communication files associated with the user and the other person can be obtained, arranged, and presented to the user in an order based on a timestamp of each conversation line in the files. However, the capabilities of the invention disclosed in the above mentioned invention is limited.

### SUMMARY

There is a need to develop a method and system to search and rank chat sessions, conversations and messages, files, images, etc. Further, there is a need of such method and system which can be applied to or integrated to different types of chat applications. Furthermore, there is need of such method and system which provides advanced hierarchy criteria and algorithm for searching and ranking the relevant chat conversations and/or parts of a chat conversation. In this way, the user gets relevant chat sessions and/or chat conversation as per his requirements.

Therefore, an objective of the present disclosure is searching and ranking of chat sessions, individual messages and/or chat conversations.

Another objective of the present disclosure is to perform searching and ranking of chat sessions/ conversations, particular text, images, audio, video, GIF etc., contained in same or different chat sessions using same or different chat platforms/applications.

Yet another objective of the present disclosure is to provide a search platform for chat applications and instant messaging services whereby such search platform includes algorithm capabilities with advanced hierarchy criteria that enable intelligent and quick search functionality.

Yet another objective of the present disclosure is to provide an intelligent sorting process corresponding to the ranking of the various chat conversations, and lines contained in different chat sessions, in the same chat session or across different chat applications.

Yet another objective of the present disclosure is to allow the user to search for relevant information around a topic present in different chat sessions, in the same chat session or across different chat applications.

Yet another objective of the present disclosure is to extract metadata like logins and passwords, URL, IP Address, geographical address, use of multiple languages for chat etc. This metadata forms basis for search in identifying results for user search query.

An object of the present disclosure is to allow user to search for a chat session/ content with or without being connected to the internet.

These and other objectives and advantages of the invention will be clear from the ensuing description.

In light of the above objects, methods and systems is proposed for searching and ranking chat sessions or conversations on different types of chat applications, such as WhatsApp™, Snapchat and the like.

The present disclosure provides processor implemented methods and systems for searching, and ranking chat conversations in a user computing device having a chat application running thereon and/ or connected to such chat database using interne or cloud computing. The method comprises receiving one or more search term from the user. Further, the method includes identifying context corresponding to the user's search term. The search term as provided herein includes at least a text, a numeral, a word, an alphabet, a special character, a text, a sign, alphanumeric, and a combination thereof. Moreover, the identification of the context of the search term as provided in the present disclosure is done on the basis of pre-defined contexts and algorithms.

After identifying the context, the present method comprises searching the relevant chat conversation over a chat application. Further, the present method includes ranking of the chat sessions and/or chat conversations, and, particular lines contained in different chat sessions or in the same chat session, and ranking of files, videos, images, audio, etc. in chat sessions, based on predefined hierarchy criteria. Further, the ranked results are sorted based on a ranking hierarchy. The most relevant chat sessions and/or chat conversations are at higher ranking hierarchy and the least relevant chat sessions will have lower ranking hierarchy. Finally, the method displays the sorted chat sessions/ conversations to the user based on the ranking hierarchy.

These aspects of the present disclosure, along with the various features of novelty that characterize the present disclosure, are pointed out in the below mentioned description. For a better understanding of the present disclosure, its operating advantages, and the specific objects attained by its uses, reference should be made to the accompanying drawing and descriptive matter in which there is illustrated an exemplary embodiment of the present disclosure.

### DESCRIPTION OF THE DRAWINGS

The advantages and features of the present disclosure will become better understood with reference to the following detailed description taken in conjunction with the accompanying drawings, in which:

FIG. 1 illustrates a block diagram of a system 100, according to an embodiment of the present disclosure;

FIG. 2 illustrates a flow diagram of method 200 for computer implemented processing of search query, and ranking chat messages, particular text, multimedia, files etc., according to an embodiment of the present disclosure;

FIG. 3 illustrates the contexts of the search term, according to an embodiment of the present disclosure ;

FIG. 3(a) illustrates a block diagram for determining the contexts of the search term, according to an embodiment of the present disclosure ;

FIG. 4 illustrates a diagram 400 depicting hierarchy criteria of ranking, according to an embodiment of the present disclosure;

FIG. 4(a) illustrates a block diagram for determining the hierarchy criteria of the search term and presenting the search results based on their ranking, according to an embodiment of the present disclosure; and

FIG. 5 illustrates a detailed flow diagram of the computer implemented method, according to an embodiment of the present disclosure.

Like reference numerals refer to like parts throughout the description of several views of the drawing.

### DESCRIPTION OF THE INVENTION

The exemplary embodiments described herein detail for illustrative purposes are subjected to many variations. It should be emphasized, however, that the present disclosure is not limited to a method and system for searching and ranking chat sessions, text, files, multimedia or conversations on chat applications. It is understood that various omissions and substitutions of equivalents are contemplated as circumstances may suggest or render expedient, but these are intended to cover the application or implementation without departing from the spirit or scope of the present disclosure.

The terms “a” and “an” herein do not denote a limitation of quantity, but rather denote the presence of at least one of the referenced item.

The terms “having”, “comprising”, “including”, and variations thereof signify the presence of a component.

It will be apparent to a person skilled in the art that the present searching capabilities in chat applications are very limited. Most likely, the inbuilt search programs ‘blindly’ match a search term as entered by the user and present a number of chat sessions for a particular search term. Further, in such inbuilt programs, the final search results are shown in chronological order without ranking the results of specific chat sessions and individual messages based on their relevance to the search term and to the user. The whole process is time consuming and frustrating and requires a lot of user's intervention.

Further, there are some other searching modules adapted for searching the specific chat sessions and/or chat conversations based on a contact name, email address as stored on a contact database of such chat application. However, the ability of all of the existing searching and ranking modules is limited, and requires considerable improvement, and a technical solution is required to be identified for solving the computing problem of retrieving relevant chat sessions in messaging/ chat applications running on their computing devices.

Moreover, the known solutions do not provide advanced hierarchy criteria for ranking the conversations. Further, the known solution is not intelligent enough to accommodate synonyms, antonyms, variation of words, acronyms, spelling mistakes, punctuations, singular and plural meanings and the like, while searching for chat sessions. For example, when a user wants to read a conversation having word ‘color’ but entered ‘colour’ as the search term, then the above mentioned invention is not intelligent enough to accommodate such mistakes in addition to not being able to rank through use of hierarchy.

Furthermore, sometimes users use multiple chat applications to communicate. In such cases, the user may search for a chat conversation in an incorrect chat application and accordingly the user may be unable to receive results because such chat application does not include that chat conversation. In such a case, the user gets exhausted until he realizes that he is searching in a wrong chat database. Accordingly, a method of searching multiple chat applications in a relevant manner is much needed.

The present disclosure provides an improved method for searching and ranking chat sessions or conversations on various chat applications. In an embodiment of the present disclosure, the searching of chat sessions is performed in a chat database stored distinct from a computing device like a hard drive or flash drive. Further, the present disclosure is also capable of searching in short message service (SMS) database. Hence, it should be appreciated by a person skilled in art that the present disclosure is utilized to search in any/ all databases of conversation including but not limited to Email(s), chat application(s), SMS and the like.

In an aspect, as described herein the terms “chat application(s)” and/or “instant messaging service” refers to a software program enabling real time communication over the Internet with a real-time transmission of text messages from sender to receiver. However, it should not be construed that the present disclosure works only for real time messages. The present disclosure of searching and ranking can also be utilized in chat applications where the messages are sent at a specific time (user defined) or with time delay or automatically after a certain amount of time, like custom messages by a user etc.

The chat application may be passive type or instant type. The chat applications work on an online platform or an offline platform. Suitable examples of such chat applications include, Gtalk™, Yahoo Messenger, WhatsApp™, Skype, ChatOn™ and other instant and passive chat software available in the art. As described herein the term “chat message(s)” refers to any text, or multimedia (image, audio, video, GIF), or digital file(s) or emoji(s) or any other conversation that takes place between two or more users.

In an aspect of the present disclosure, the “users” conversing with each other on chat databases or applications could be humans, or human(s) conversing with machine (like user asking questions from Google via “Ok Google” or Siri for iPhone), or two or more machines. Hence, the term “user” should not be limited to humans and should be understood as human and/ or machine (computer).

The present disclosure is a computer implemented method adapted to perform searching and ranking of chat conversations with the help of a computer assisted platform such as a plug-in, an add-on program, or other similar platforms. Such computer assisted platform or plug-in may or may not be connected with the chat applications having chat database based on user contact number, user name, user profile, user email and the like. The chat contact database includes at least a chat conversation, a chat session, a chat history or a chat message wherein the present disclosure can perform a search.

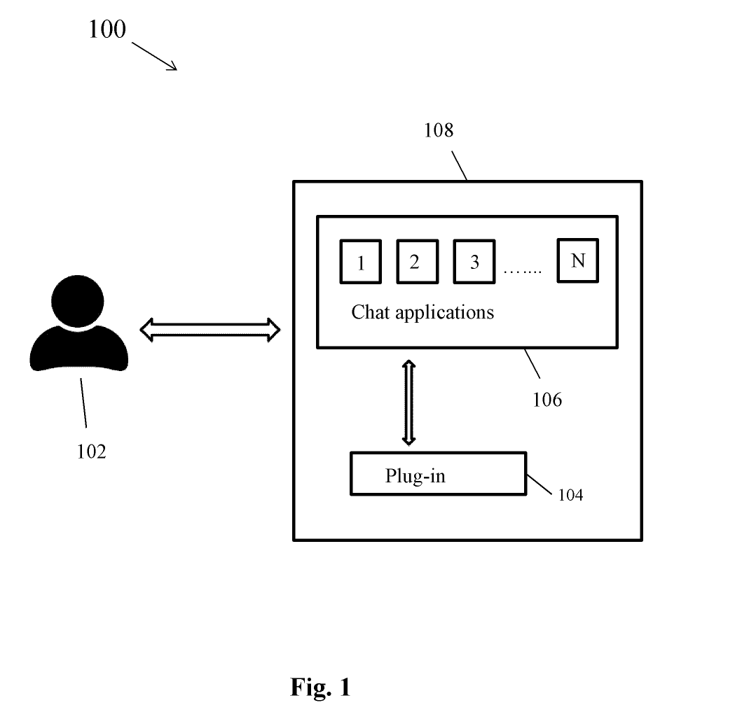

The searching and ranking of chat sessions and/or chat conversations is based on one or more pre-defined contexts and algorithms. The methods and the algorithms used will now be explained in conjunction with FIGS. 1-4(a) as below.

Now referring to FIG. 1, a system 100 has been shown where the implementation of the invention is illustrated with respect to the environment. FIG. 1 includes a user 102. In another aspect, the user 102 is a machine conversing with another user (human and/ or machine) via computing device 108. The user 102 is shown to be using a computing device 108 such as a PDA (personal digital assistant), a desktop, laptop, a computer, a mobile phone, a tablet, a processor based wearable device, or a communication device and the like.

Further, the system 100 includes a chat application 106 and a search platform 104 such as a plug-in configured in a user computing device 108. The search platform can be in the cloud (servers) and not necessarily configured in a user computing device. Suitable examples of the chat applications 104 include, but are not limited to, Skype, WhatsApp™ and other like software. The method and system as per various embodiments of the present disclosure allow an improved searching and ranking of relevant chat sessions or conversations on these chat applications.

In various embodiments of the present disclosure, the computer implemented method of searching and ranking a plurality of chat conversations is a search engine connected to atleast a chat application or database. This search engine has its own interface and is launched exclusively for searching. In another embodiment, the present method of searching and ranking is a plug-in installed or integrated in chat applications or databases as a search bar/ tool/ menu. In yet another embodiment, the present method is both a search engine with its interface and exclusiveness and a plug-in integrated in chat applications.

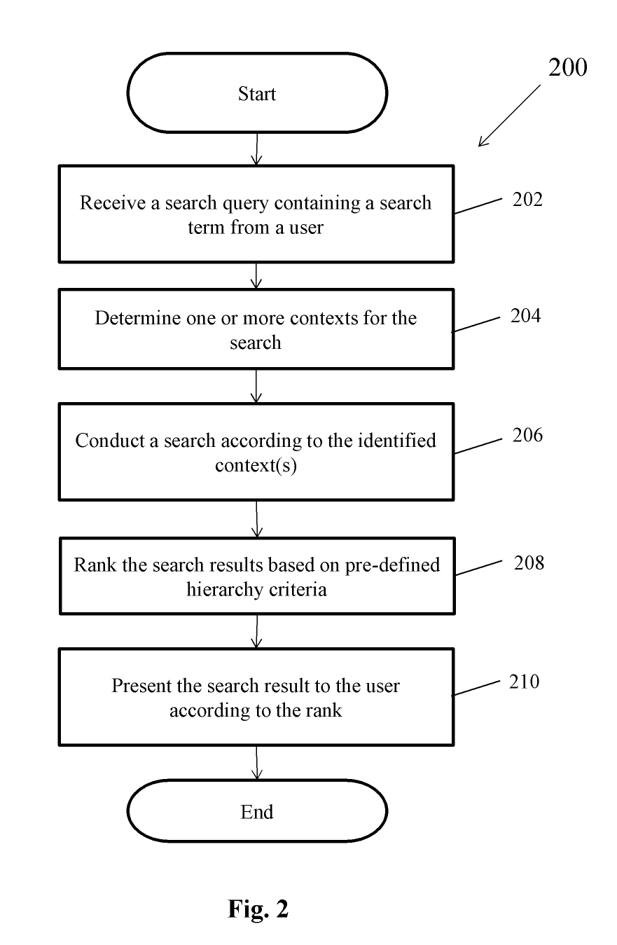

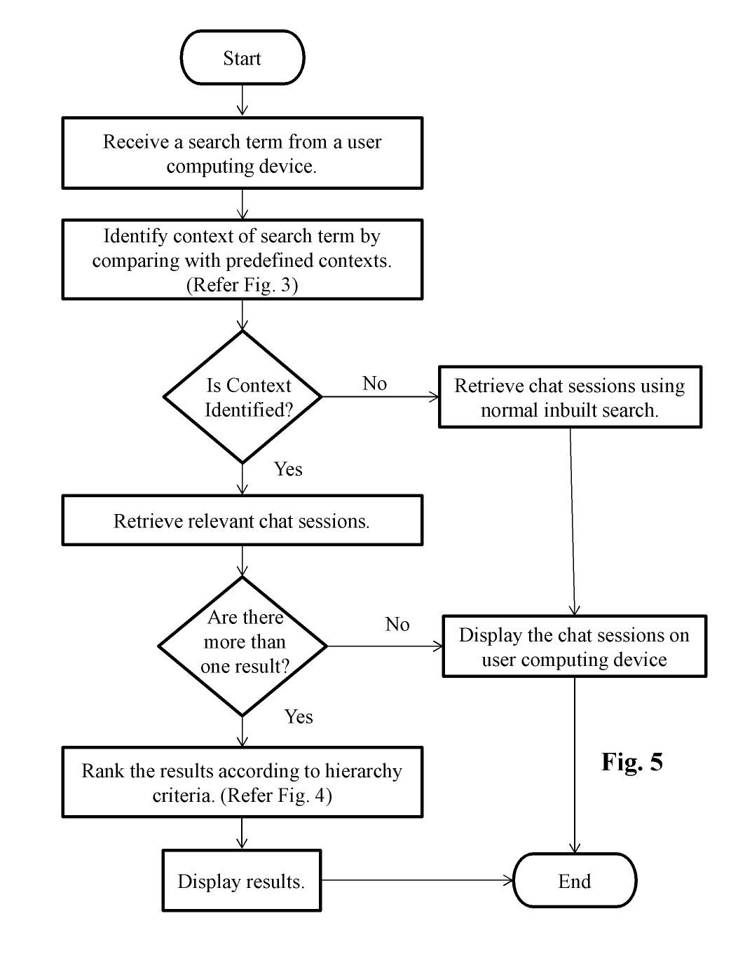

In an aspect of the present disclosure, computer implemented method uses a search platform 104 which is connected to the chat applications 106. The search platform 104 facilitates the searching and ranking of the chat sessions or conversations on chat applications 106. The functioning of the plug-in 106 is explained with reference to FIGS. 2-4(a), and 5.

Now referring to FIG. 2, a method 200 for searching and ranking chat messages is shown. The method starts, at step 202, where a search query as entered by the user is received by the computing device 108 via the search platform 104. The said search query includes one or more search terms as entered by the user.

In an aspect of the present disclosure, the search query is input by the user using a keys, or touch screen, or voice, or image, or video, or gestures like “waving”, and the like.

In an embodiment of the present disclosure, when user 102 wishes to search for a particular search term(s), then such search term(s) is entered in the search platform 104.

In another embodiment of the present disclosure, the present computer implemented method can be dynamically attached to one or multiple chat applications. In an implementation, the present method provides an independent search interface different than that of the chat application. The said independent search interface is adapted to search the search term of the user choice. Further, the present method has multiple tools or options for the user to modify, restrict or broaden the search criteria.

In an embodiment of the present disclosure, the search term can be in the form of one or more text including a numeral, word, alphabet, special character, text, sign, alphanumeric or a combination thereof, multimedia like audio, video, image, emoji etc. In addition to providing one or more search terms, the user has the option to select one of the advanced search options given in the drop-down menu or other kinds of menus provided by the search platform 106.

The method 200 then flows to step 204. At step 204, the method determines one or more contexts for the search. The context is associated with the search term(s).

Further, at step 206, the method conducts a search according to the identified context(s). Then, the method moves to step 208, where the method ranks the results of the search, the ranking is done as per predefined hierarchy criteria.

Finally, at step 210, the method displays/presents the search results according to a ranking done at previous step. Thereafter, the method terminates.

The present disclosure will be better understood by considering the examples as below.

In one embodiment, as per the example illustrated above, in case the user may input “book” as a search term, at step 204, the method 200 determines at least one context of the search using the received search term. In the instant case, the search platform 106 determines the context amongst pre-defined contexts. For example, for input “book”, it is determined that the user is looking for a chat session that has term “book” in the conversation.

In various embodiments, the pre-defined contexts include “attachment”, “attachment with attachment name” “metadata”, “person” and “general term” which includes the body of the chat session or conversation.

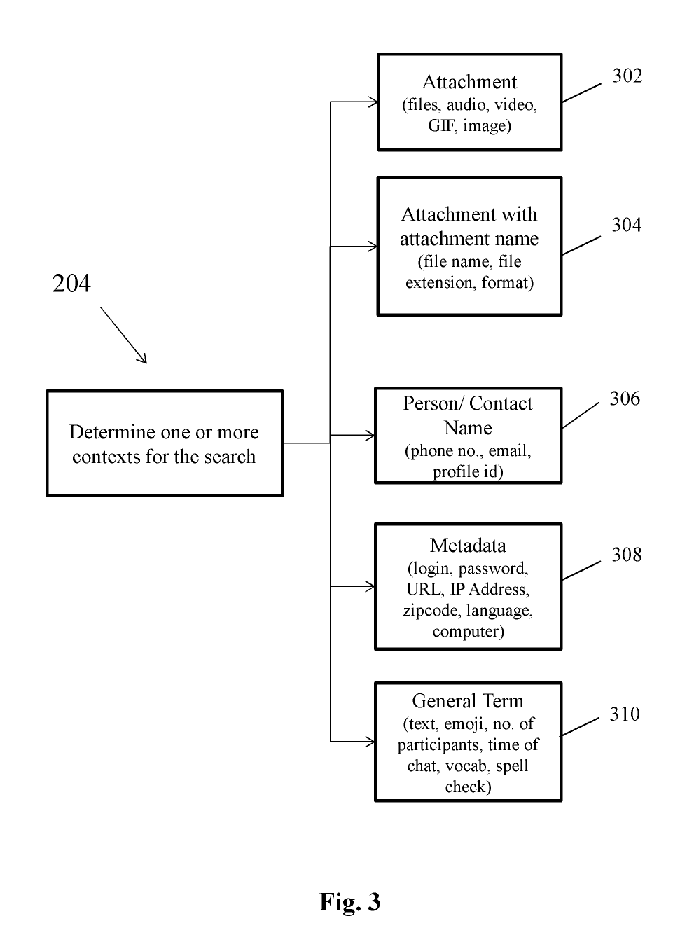

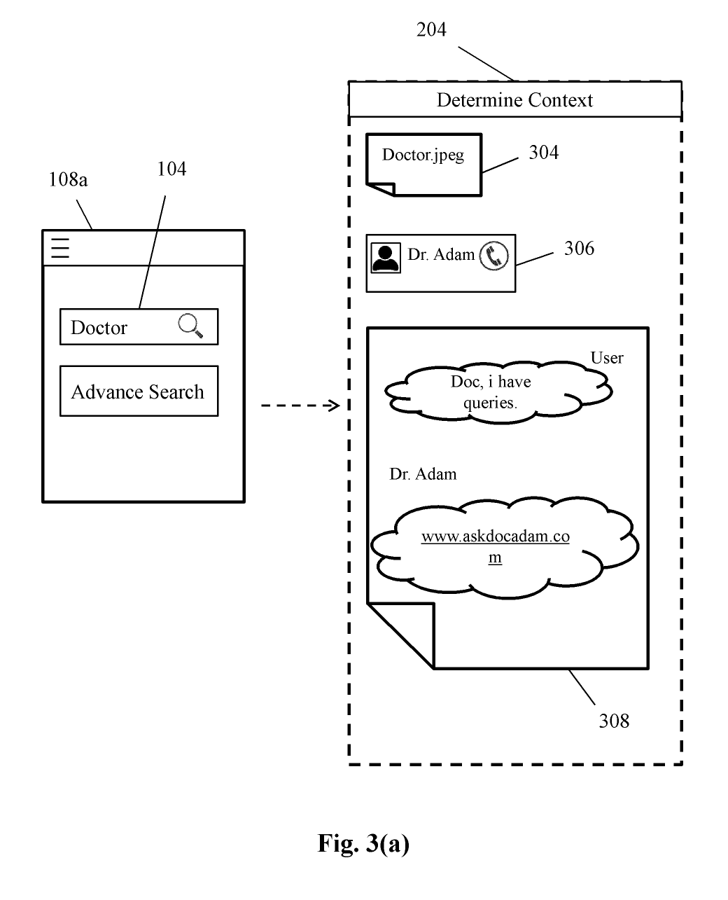

In various embodiments of the present disclosure, the identification of context of the search is done as illustrated in FIG. 3 and FIG. 3(a).

Now referring to FIG. 3, which provides an illustration for the determination of context as prescribed at step 204 of FIG. 2. In an implementation, referring to 302, the present method checks whether the search refers to an attachment. Attachment includes any/ all files related to word, PowerPoint, excel, setup file, pdf, or any other digital file. Further, attachment also includes audio, video, graphic interchange format (GIF), image and the like.

In an implementation, referring to 304, attachment with attachment name is a context related to the attachment details such as name given to a file type, file format, file size, author and the like. The context 304 is an extension of the context 302.

For instance, if a user enters “patent.jpg” as a search term in the search box provided by the plug-in 104, the method 200 determines the context to be related to an “attachment” 302, image called “patent” and “attachment with attachment name” 304, format “.jpg”. Thus, user is presented with the results accordingly. For example, if the user is looking for an image that was sent or received in a past chat conversation and types “.png” as search term, the method 200 at step 204 identifies the context as “attachment with attachment name”. In an implementation, the presentation of search results is based on ranking via various pre-defined hierarchy criteria.

In another embodiment, if the user enters “patent.png” as the search term, the context is identified as “attachment with attachment name” 304 and then all the results containing images are presented to the user. The images of other file formats such as “.jpg”, “.jpeg”, “.bmp” and the like, are also presented to the user alongwith the “.png” type in a chronological order.

In an implementation to the example mentioned above, the searching at step 206 on the basis of identified context 304 not only generates results with file name “patent” and file type “.jpg” but the searching also considers files with same name and different format type or files with different names but same format type. This may be done when searching for “patent.jpg” gives no precise results.

In another implementation, referring to 306, the determination of context of the search term is on the basis of person/ contact name. This determination at 306 is based on phone number, email, profile id, user name etc. For example, if the step 204 determines that the search term entered is a contact name in the chat database, chat sessions for that particular contact are selected as search results at step 206 for presentation based on hierarchy criteria in step 210.

In another implementation, referring to 308, the determination of context of the search term is on the basis of metadata. The various search terms that are identified as context metadata 308 are login/ username, password, URL, IP Address, Zip code, language(s) used during chatting, type of computer (private or public). It is determined that the context of the search term is a metadata, and then search at step 206 is conducted considering the metadata. For instance, say the user had a conversation with his friend regarding a website “http://methodforsearching.com”. The next day, the user inputs “method for searching” as a search term, the step 204 determines the context for the search to be a metadata 308, more specifically a URL and searches for the same in the chat databases of chat applications 106. The URL has a different syntax than a normal text and has a link which is capable of guiding the user to a webpage.

In another aspect, the metadata is related to a username or account name and password. For example, two users are chatting regarding an account on a website and decide to share the account. Next day, when the other user wants to login into the said account, he would simply search with the search term as “username” or “login” or “password” and he would be presented with results that mention details of any/all accounts.

Further, the present method and system is adapted to follow a logic of multiple variation of login like login, username, ID and look for words contacting alphanumeric, numeric, special characters and/or a combination of all, which is spaced up to a pre-defined number of characters, like say for example 30 characters. The method and system would thus be able to locate usernames and passwords and various combinations thereof like for example flight numbers, UPS courier packages etc.

In yet another aspect, the metadata is an “IP address”. Since, the computing device need an IP address, this context i.e. metadata helps in identifying particular chat session based on IP Address.

Further, if a user is engaged in a group chats with people who are linguists and use different languages for a single chat or multiple chats. Later, if the user wants to retrieve that specific chat session, all he has to do is to enter the search term as “English, Spanish, French” or “Language” or a combination thereof. The method 200 identifies the context at step 204 as metadata 308 related to “language” and said chat session is retrieved easily. This feature can be very important for law enforcement agencies.

In an aspect, the metadata is related to type of computing device used for a chat session. Say, a user converses with another user using a computer at the university library. The method and system is intelligent enough to identify that this type of computer is a public computer and whenever the user wants to retrieve the conversation where such computer is used, all he needs to do is enter the search term as “public computer” and the method identifies the context as metadata related to type of computer. Accordingly, the results are presented with chat sessions that occurred using public computer(s).

In yet another implementation of the present disclosure, referring to 310, the determination of context of the search term is on the basis a general search term. The search term entered is a general search term, if the said search term is not present in any of the context categories as discussed hereinbefore. In such a case, the whole chat database is searched for the said search term. For example, suppose the user had conversations with his friend(s) regarding “invention” and later searches for the chat sessions involving the same by entering “invention” as the search term. Now, the search term is not based or connected to any of the context types as referred at 302, 304, 306, or 308 and thus the “General Term” 310 is selected as a context in step 204.

In various embodiments of the present disclosure, the context as “General Term” 310 includes text, emoji (ideograms and smileys used in electronic messages and Web pages), number of participants, vocabulary, spelling check.

In an implementation, the context of the search term is determined on the basis of emoji. For example, if the user is searching for a chat session where constantly a particular type of smiley was used. And the said user enters the search term as “emoji” or enters that particular emoji then the user is presented with results based on identified context as “General Term” 310 as emoji.

Accordingly, the context general term also includes search that is done based on synonyms and/ or antonyms of the search term. Further, if the user searches for “colour” then the method first looks for an exact match of “colour” and if not found, or if the results are not of a minimum number, the system may also search for “color”.

In an embodiment of the present disclosure, the determination of context 204 is not restricted to any order or to a specific context type. The method 200 may determine the context to be of multiple types and not limited to a specific type. For example, if user enters “Vinay” as a search term. The method 200 checks at step 204 and searches for the search term regarding it as context type 302, 304, 306, 308, 310 and/ or a combination thereof. This example has been defined considering that a search term may satisfy more than one context.

The above mentioned examples for context are for illustrative purposes only and should not be construed as the only possible ways to determine the context. Further, the search can be performed by selecting all the contexts and/ or multiple contexts simultaneously.

FIG. 3(a) provides an exemplary illustration for determining the context of the search term. FIG. 3(a) shows a user computing device 108(a) along with the search platform 104. The user inputs “Doctor” as the search term over the search platform 104.

FIG. 3(a) shows that the determination of context 204 is done in the backend of the method 200. According to the search term, the method identifies a jpeg file named “doctor” and hence the search term is associated with context 304 which is related to name of the attachment.

Further, the method encounters a contact named Doctor Adam and identifies the search context as contact name 306. This is identified as context related to “General Term” 310 of vocabulary. The method 200 then associates the search term with the metadata 308 seeing that user had chats with a contact where a web website named www.askdocadam.com was also mentioned. Hence, multiple contexts are identified, i.e.

“Person/ Contact Name”, “Metadata” as URL, and “General term” as vocabulary. Further, it is to be understood that the present system and method is intelligent enough to understand that the term “Doctor” is also written as “Dr.” and vice versa. Thus, present system and method also provides search results having “Dr.” mentioned therein for the search term “Doctor”.

In various embodiments of the present disclosure, the searching 206 of chat databases is done based on several parameters.

In accordance with an embodiment, the method 200 is capable of searching for synonyms, antonyms and variation of words for the search term as provided by user. Specifically, if the method 200 does not get any exact match for the search term, then method 200 searches for synonyms, antonyms and variation of words. For example, if the search term is “book” then the method 200 may search and find out the results related to “novel”, “volume”, “tone” and the like.

These results will be presented to the user if the method 200 does not locate any exact match for the search term “book” or if the method 200 determines that the exact match is of low importance and there is a need to search further.

As per another embodiment, the method 200 is capable of searching 206 for spelling mistakes, acronyms, punctuations, singular and plural terms etc. of the search term as provided by the user. Specifically, the present computer implemented method is intelligent enough to understand the correct spelling of a misspelt word. For example, if the user enters the search term “knowldge” by mistake, then the method 200 will find out the results related to “knowledge”. Also, the method 200 makes it easier for the user to input various search terms and is extremely flexible to accommodate acronyms, spelling mistakes, punctuations, singular and plural meanings of the search term. The method 200 also finds out various connotations of the same search term like use of “Bill” and “William” interchangeably, finding common terms, which refer to the same thing or place like SF, San Francisco, San Fran etc.

In an embodiment of the present disclosure, the method 200 is capable of identifying variations of terms such as UNO. If a user enters search term “UNO”, the method 200 first searches for exact match (considering context as general term) of the term. In case when the method 200 finds no results or limited number of results or if the user wants to see more results, the method 200 searches for variations of the search term.

For instance, the user may enter variations for UNO as uno, u.n.o.,

United nation organization, united nations, united nations org etc. In such scenarios, the method 200 understands that the user is searching for “United Nations Organization”.

In a different scenario, if a user searches for “stereo amp”, and if the method 200 is unable to find any suitable result then it searches 206 for variation such as “audio amp”.

As per another embodiment, the method 200 first matches all the words of the search term and then some of the words. Specifically, if the user enters two words as a search term, then the method first searches for those two words as a whole.

Moreover, if the method 200 does not get any exact match for those two words as a whole, then it further searches for all the terms individually. For example, if the user enters the search term “patent pending process”, then the method 200 searches for all the terms as entered i.e. adjacent to each other. Further, if method does not get any results then method searches for the term “patent” separately followed by the other search on the search term “pending” and “process”. This searching criterion is applicable whenever a search term includes two or more than two words.

The search query for “patent pending process” first may return results in the form of various chat sessions for topics which have:
i) all of the search terms next to each other without any other words in between;
ii) all the search terms in at least one chat conversation but not necessarily next to each other;
iii) any two search terms next to each other in at least one chat conversation;
iv) any two search terms in at least one chat conversation but not necessarily next to each other;
v) any one of the search terms is present anywhere in at least one chat conversation.

Users sometimes misspell various words. Also, British English is different from American English and words are spelt differently in British English as compared to American English. For example the word color is spelt as “color” and “colour” by the Americans and by the British respectively. In such cases it might be difficult for prior systems of searching to find the term “color” in a topic because the user might spell it as “colour”.

In such cases, the present computer implemented method looks for spelling versions of the word where the word is spelt differently. The method 200 provides searching in various ways in which words are spelt in different parts of the world. The variations of words will be pre-loaded in the system and in instances where the method cannot find one spelling version of the search term like “color” it looks for the term “colour” as another spelling version.

In another implementation, if a search term has no other variants in the preloaded database of words of the present computer implemented method then different variants of the search term can be extracted from the internet and used for searching.

Users are sometimes unable to remember the exact way in which something was described in a topic. For example some users may describe the University of Michigan as U of M, Univ of Michigan or U Mich. In such cases the method 200 will look up different ways in which the search query may have been written in a topic. When a user enters the search term “U of M” the method will look for the words “U of M” and will also look for the words “University of Michigan, Univ of Michigan, U Mich” and any other possible words that might be used interchangeably with the search term “U of M.”

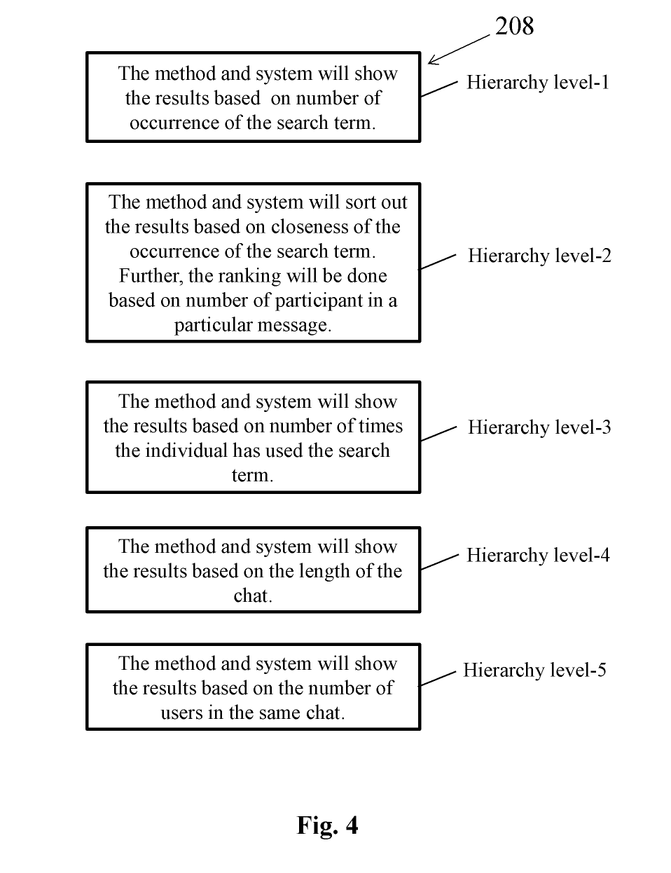

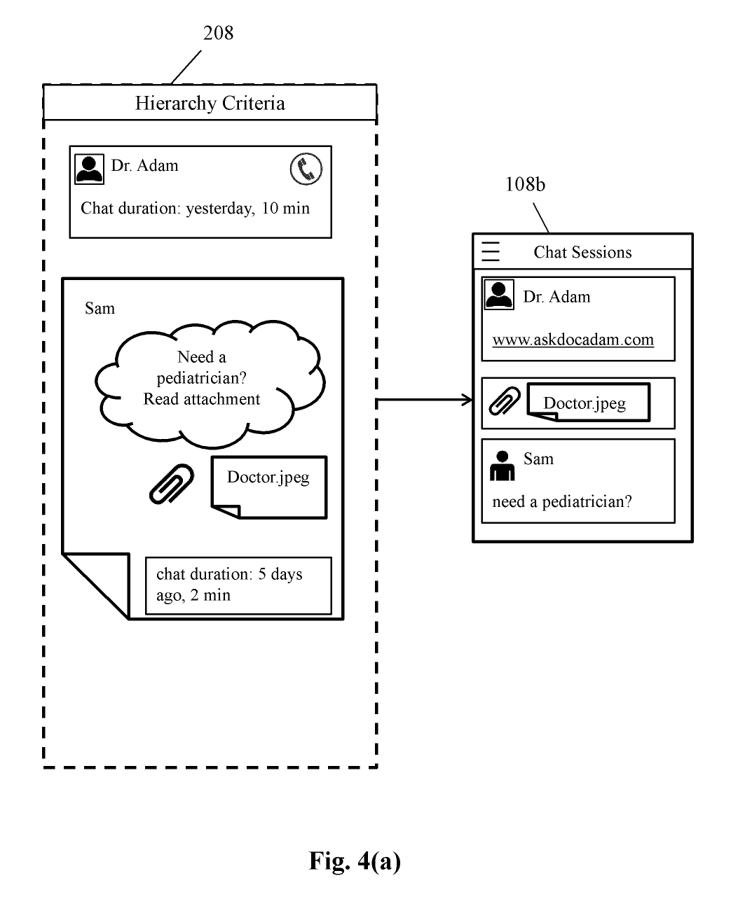

In various embodiments of the present disclosure, the ranking of the search results is illustrated in FIG. 4 and FIG. 4(a) as provided herein. In various embodiments of the present disclosure, the ranking 208 is done as per predefined hierarchy criteria illustrated in FIG. 4.

In one embodiment, the said ranking of the chat sessions or chat conversations, or particular lines contained in different chat sessions or in the same chat session is according to their relevancy corresponding to the search term.

Now referring to hierarchy level-1 as illustrated in FIG. 4, the method 200 ranks the chat conversations based on the number of occurrence of the search terms in the said chat conversations. Specifically, those results are shown higher in the results list which include search term more number of times. For example, a chat session including the search term occurring five times is shown higher in result as compared to the chat session with the search term occurring three times.

As per another embodiment, the method 200 shows the results based on closeness of the occurrence of the search term as depicted in hierarchy level-2 in FIG. 4. Specifically, those results are shown higher in the result list, which include search term very close to each other repeatedly. For example, a chat session including the search term four times and that too adjacent to each other, is shown higher in the result list as compared to a chat session including the search term four times but occurring non-adjacent to each other. The system is pre-loaded with the number of characters apart the two words are to be considered adjacent and non-adjacent. Further, a higher hierarchy ranking is given if the words are appearing in the messages of a single individual participant than if the words are part of individual messages of more than one participant.

Further, as per another embodiment, the method 200 shows the results of chat sessions based on number of times a particular user has used the search term as depicted in hierarchy level-3. Specifically, if the user has used one particular term many times, then the method gives messages from that user higher weightage.

In another embodiment, the method 200 shows the results based on length of the chat or conversation as depicted in hierarchy level-4. Specifically, those results are shown higher which have minimum cut off length or which are longer in length. For example, as per one embodiment, a chat session having twenty lines is shown higher in the result list as compared to a chat session having three lines.

In yet another embodiment, the method 200 shows the results based on number of users in the same chat as shown in hierarchy level-5. Specifically, results with higher number of people are shown higher in the result list. For example, as per one embodiment, a chat session having assembly of five people may be shown higher in result list as compared to the chat session having assembly of three people.

In yet another embodiment, the results are ranked on the basis of time of occurrence of chat like latest first. Further, the ranking is based upon the type of contact, say one of the contacts is marked important, so, the results for a search term with that particular person are displayed first.

In yet other embodiments, chat sessions with special characters, dates, and other specific information including but not limited to the following are ranked higher. a) numeric; b) currency symbols; c) numeric and alphanumeric within the same word, for example A24GDFGDG; d) numeric, alphanumeric and special characters within the same word like ergeg$#435g or any combination thereof; e) URL's (f) certain keywords which may have been interchangeably used like telephone number or mobile number; g) set of keywords which have a certain pre-defined distance from each other like the keywords id and password, found within a pre-set distances say for example 50 characters of each other, or any such variations of keywords; (h) time in a pre-defined format like 1.30 p.m or 13.30 hours or dates in a pre-defined format like 12 August or August 12th; (i) names of places for example San Francisco or SF; (j) days of the week like Wednesday or Wed; months of the year like August or Aug; (k) certain pre-defined active phrases including but not limited to “let's meet up”; 1) question phrases such as when a question is asked like “what is your schedule?” and the like; m) flight numbers; n) ticket numbers; o) reservation numbers; p) tracking numbers; q) order numbers; r) session id numbers; s) addresses; t) complaint numbers; u) birthdays; v) anniversaries; w) holidays; x) festivals; z) event dates and/or details like the date of an upcoming concert; (aa) stock ticker symbols; (ab) stock prices; (ac) stock exchange indices; (ad) commodities exchange indices; (ae) exchange rate details; (af) price of a product or service; (ag) phone numbers; (ah) fax numbers; (ai) zip codes.

FIG. 4(a) provides an exemplary illustration for determining the hierarchy level for the search term “Doctor”. Here, the search results are ranked on the basis of hierarchy criteria. Among various parameters of hierarchy levels as provided by the present disclosure, in the first example the method identifies that the user had chats with Dr. Adam on the previous day for 10 minutes and the chats involved the user using the word “Doc” and Dr. Adam replying with words www.askdocadam.com.

Here in this case, there are two words present in the chat session which are matching with the search term “doctor” i.e. “Dr. Adam” as the other chat user and “www.askdocadam.com” as the domain name. Hence, it is to be noted that in this chat session there are two hierarchy criteria matching with the search term “doctor” and the chat is recent one and thus this chat session has to be ranked higher as compared to the chat sessions which have less than two hierarchy criteria and/or which is much older to this chat session. So, as this chat session contained hierarchy level-1 and 4, hence, the method ranked it higher.

Further, in the second example, the method discovers that the user had chats with his contact named “Sam” who mentioned the word “pediatrician” and sent a file named “Doctor.jpeg” to the user. The computer implemented method for searching and ranking chat conversations then identifies that this conversation occurred five days ago and for 2 minutes, therefore, ranks it second based on various hierarchy levels.

Here in this case, there are two words present in the chat session which are matching with the search term “doctor” i.e. “pediatrician” as the chat word and “Doctor.jpeg” as the chat file. In this case, the method identifies that “pediatrician” is a synonym for the search term “doctor”. Further, it is to be noted that in this chat session there are two hierarchy criteria matching with the search term “doctor”. However, this chat session is older one as compared to the above disclosed chat session which is only one day older and thus this chat session has to be ranked lower as compared to the recent chat sessions.

As mentioned above, the determination of context and ranking of the search results are carried out at the backend and are not visible to the user. The presentation of search results happens later when the results are ranked on his the computing device 108b. The devices 108a and 108b are same devices but at different instants of time. The display on device 108a is when the method 200 begins and the display on device 108b is when the method terminates after presenting the results to the user.

Accordingly, the presentation of chat sessions on device 108b shows the chats with “Dr. Adam” which occurred the previous day for 10 minutes, containing the URL “www.askdocadam.com” as the first search result and at the top of all the search results. Then this first search result is followed by search result having the chat session with Sam where he mentions the word “pediatrician” and with the file “Doctor.jpeg” attached in the chat session as disclosed hereinabove.

In yet another embodiment, the present method provides an advanced search option, where the user can manually choose to search chat sessions based individually on the parameters outlined above. For example, the advanced search may have pre-defined fields like URL, mobile number, and the like, where the user can enter his search term and get the results.

In an aspect of the present disclosure, the method for searching and ranking of chat conversations presents results to the user without the user even inputting a search term. For example, if the user opts to search for chat sessions via the interface provided by the present method, the method presents suggestive chat sessions. This automatic suggestion requires the present method to remember the user search history, pattern, time of day, seasons, user's location, trending news etc.

In an embodiment, the location of the user is used to present chat sessions. For example, the user travels to Chicago from New York and opens up a chat application. The present method identifies the user's location and presents the user with those chat results having users who are present in Chicago.

In another exemplary embodiment, say, the user frequently chats with “A” in the evening after 6, especially on the topics related to sports. And, there's a Knicks game approaching. Now, when the user opts to search a chat conversation at 7 pm, the present method of searching and ranking presents the latest chat session with “A” that shows both user and “A” in a chat for more than 5 minutes where the word “Knicks” was used, as suggestive result without the user even inputting search term. The method recognizes the user's pattern of chatting with “A” in evening, plus the method gathers from the internet that there is a game coming up. This is a mere exemplary implementation of the present disclosure and it is not supposed to limit its scope.

The computer implemented methods for searching and ranking as disclosed in the present disclosure provides faster computation time, reduces the processing burden on processing elements of a computing device, and increases the quality of the chat sessions retrieved by the search. The disclosed searching algorithms which are based on identification of context of the inputted search term and the subsequent ranking algorithm eases the computing load on a processor of the computing device and significantly increases the relevance of the output, which is the chat sessions retrieved in a chat application running on a computing device.

It should be noted that the exemplary embodiments pertaining to ranking as described in the preceding paragraphs should not be construed as a limitation to the present disclosure.

Accordingly, many variations of these embodiments are envisaged within the scope of the present disclosure.

Further, the present disclosure should not be construed to be limited to the configuration of the method and system as described herein only. Various configurations of the system are possible which shall also lie within the scope of the present disclosure.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present disclosure.

The system as described in the disclosed teachings or any of its components may be embodied in the form of a computer system. Typical examples of a computer system include a general-purpose computer, a PDA, a cell phone, a programmed microprocessor, a micro-controller, a peripheral integrated circuit element, and other devices or arrangements of devices that are capable of implementing the steps that constitute the method of the disclosed teachings.

In a computer system comprising a general-purpose computer, such may include an input device, and a display unit. Specifically, the computer may comprise a microprocessor, where the microprocessor is connected to a communication bus. The computer may also include a memory the memory may include Random Access Memory (RAM) and Read Only Memory (ROM). The computer system further comprises a storage device it can be a hard disk drive or a removable storage drive such as a floppy disk drive, optical disk drive, and the like. The storage device can also comprise other, similar means for loading computer programs or other instructions into the computer system.

The computer system may comprise a communication device to communicate with a remote computer through a network. The communication device can be a wireless communication port, a data cable connecting the computer system with the network, and the like. The network can be a Local Area Network (LAN) or a Wide Area Network (WAN) such as the Internet and the like. The remote computer that is connected to the network can be a general-purpose computer, a server, a PDA, and the like. Further, the computer system can access information from the remote computer through the network.

The computer system executes a set of instructions that are stored in one or more storage elements in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the disclosed teachings. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The software program or programs may be provided as a computer program product, such as in the form of a computer readable medium with the program or programs including the set of instructions embodied therein. The processing of input data by the processing machine may be in response to user commands or in response to the results of previous processing or in response to a request made by another processing machine.

What is claimed is:

1. A computer implemented method for searching and ranking a plurality of chat conversations in a user computing device having a chat database, the computer-implemented method comprising:
receiving at least one search term from a user over the user computing device;
identifying a context of the search corresponding to the at least one received search term;
searching at least one received search term in the chat database and retrieving at least one search result based on the context of the search;
ranking each of the retrieved search results, wherein, the ranking is based on a pre-defined hierarchy criteria;
sorting at least one search result, wherein the sorting is based on the ranking of the retrieved search results; and
displaying the said sorted results through the user computing device.

2. The computer-implemented method as claimed in claim 1, wherein search results comprises at least a chat conversation, a chat session, a chat history, a chat message and at least a chat contact.

3. The computer-implemented method as claimed in claim 1, wherein the context of the search is based on at least an attachment, an attachment with attachment name, a list of person name or contacts, a metadata and a general term, wherein general term is the search term giving context other than context of an attachment, an attachment with attachment name, a person, and a metadata.

4. The computer-implemented method as claimed in claim 1, wherein searching the at least one received search term in the chat contact database comprises: searching at least an exact match of the search term.

5. The computer implemented method as claimed in claim 1, wherein searching the at least one received search term comprises searching at least the synonyms, antonyms and variation of words corresponding to the search term.

6. The computer implemented method as claimed in claim 1, wherein searching the at least one received search term comprises searching at least the acronyms, connotations, spelling mistake, punctuations, singular and plural meanings corresponding to the search term.

7. The computer implemented method as claimed in claim 1, wherein searching the at least one received search term comprises searching at least a spelling version of the search term.

8. The computer-implemented method as claimed in claim 1, wherein searching the at least one received search term in the chat contact database comprises searching at least a plurality of search terms.

9. The computer-implemented method as claimed in claim 8, wherein searching at least the plurality of search terms comprises searching at least the plurality of search terms next to each other without any other words in between thereof.

10. The computer-implemented method as claimed in claim 8, wherein searching at least the plurality of search terms comprises searching at least the plurality of search terms in at least one chat conversation but not necessarily next to each other.

11. The computer-implemented method as claimed in claim 8, wherein searching at least the plurality of search terms comprises searching at least two search terms next to each other in at least one chat conversation.

12. The computer-implemented method as claimed in claim 8, wherein searching at least the plurality of search terms comprises searching at least two search terms in at least one chat conversation but not necessarily next to each other.

13. The computer-implemented method as claimed in claim 8, wherein searching at least the plurality of search terms comprises searching at least one search term anywhere in at least one chat conversation.

14. The computer-implemented method as claimed in claim 1, wherein searching comprises interchangeability of words while searching for more than one search term.

15. The computer-implemented method as claimed in claim 1, wherein the ranking is based on a pre-defined hierarchy criterion.

16. The computer-implemented method as claimed in claim 1, wherein the sorting is based on the ranking associated with the each of the retrieved search results.
